(19) United States
(12) Patent Application Publication
(10) Pub. No.: US 2015/0078827 A1
(43) Pub. Date: Mar. 19, 2015

(54) Induction heating system for thermal desorption processes

(71) Applicant: RETERRO, INC., Pleasanton, CA (US)

(72) Inventors: Patrick Richard Brady, Sisters, OR (US); Brian Desmarais, Kenebunk, ME (US)

(21) Appl. No.: 14/485,671

(22) Filed: Sep. 13, 2014

Related U.S. Application Data
(60) Provisional application No. 61/878,620, filed on Sep. 17, 2013.

(51) Int. Cl. B09C 1/06

(52) U.S. Cl. CPC B09C 1/065; B09C 1/06
USPC 405/128.75; 405/128.85

(57) ABSTRACT

Contaminate soil can be treated using inductive energy. An inductive generator can generate inductive power to heat inductively heatable elements disposed in the contaminate soil or in a soil box. Input treatment gas can pass through the heated soil to remove contaminants in the soil to the exhaust. The inductively heatable elements can be placed in a mesh conduit, which can heat the input treatment gas.

The present application claims priority from U.S. provisional patent application Ser. No. 61/878,620, filed on Sep. 17, 2013, entitled: “Induction heating system for thermal desorption processes” which is incorporated herein by reference.

### BACKGROUND

The use of petroleum hydrocarbons as a fuel source is ubiquitous in society. Consequently, petroleum hydrocarbon products are stored and handled in great quantities. One risk associated with the storage and handling of petroleum hydrocarbons is the potential for spillages during handling or the potential for leakage during storage. Due to the negative environmental impact associated with spills and leakages of petroleum hydrocarbons, rules have been established at the local, state and federal levels. These rules primarily focus on preventing petroleum hydrocarbon releases to the environment from occurring. These rules also have provisions that require the responsible party to remediate petroleum hydrocarbon releases to the environment.

In the field of petroleum hydrocarbon remediation from soil, there are two basic approaches: applying a treatment technique to soil in place (in-situ), or applying a treatment technique to excavated soil (ex-situ). There are advantages and disadvantages for each approach and the selection of the approach is based on the site-specific circumstances of each petroleum hydrocarbon release.

Ex-situ thermal desorption technologies can include techniques that involve mechanical agitation of the soil during the heating process, which involve mechanical agitation and operate in a continuous process where the soil is continuously introduced to the process and is mechanically moved through the process apparatus until treatment is complete, and then is continuously discharged to a container for disposal or re-use.

Alternately, the soil can be treated in a static configuration, in which a given amount of soil is introduced to the treatment chamber. The soil configurations can include pile arrangement and container arrangements.

Nearly all the prior art processes use combustion of fossil fuel as a heat source. This can have the undesirable consequence of forming products of incomplete combustion, oxides of nitrogen, and other greenhouse gases as a by-product. Combustion also has the potential to add unburned hydrocarbons to the process exhaust gas if strict control of the combustion process is not maintained.

There can a need for an ex-situ static process that is labor, time and energy efficient in the treatment process, and is environmentally friendly.

### SUMMARY

In some embodiments, the present invention discloses systems and methods for treating contaminate soil using inductive energy. An inductive generator can be coupled to a treatment chamber, and can generate inductive power in the treatment chamber. Inductively heatable elements can be disposed in the contaminate soil or in a soil box, which can be heated by the inductive generator.

The inductively heatable elements can include elements fixedly coupled to the soil box, such as steel bars horizontally or vertically welded to the soil box. The inductively heatable elements can be configured to heat the soil uniformly. The inductively heatable elements can include elements disposed in the soil, such as steel balls dispersed in the soil.

The inductively heatable elements can be placed in a mesh conduit, which can accept an input treatment gas. The treatment gas can be heated when passing through the inductively heatable elements, and then released to the soil to treat the soil.

### BRIEF DESCRIPTION OF THE DRAWINGS

FIGS. 1A-1B illustrate schematic evaporative desorption systems according to some embodiments.

FIGS. 2A-2B illustrate induction heating systems for a thermal desorption process according to some embodiments.

FIGS. 3A-3E illustrate soil box configurations having inductive heatable elements according to some embodiments.

FIGS. 4A-4B illustrate flow charts for forming systems to treat contaminate soil according to some embodiments.

FIG. 5 illustrates a soil box positioned in a treatment chamber according to some embodiments.

FIG. 6 illustrates a flow chart for treating contaminate soil according to some embodiments.

FIG. 7 illustrates a soil box positioned in a treatment chamber according to some embodiments.

FIGS. 8A-8F illustrate a sequence of treatment using dispersed inductively heatable elements according to some embodiments.

FIG. 9 illustrates a flow chart for processing a contaminate soil according to some embodiments.

FIG. 10 illustrates a thermal desorption system using inductive heating according to some embodiments.

FIGS. 11A-11C illustrate connection ports for treatment gas coupling according to some embodiments.

FIGS. 12A-12C illustrate thermal desorption systems using inductive heating according to some embodiments.

FIG. 13 illustrates a flow chart for treating contaminate soil according to some embodiments.

FIG. 14 illustrates a thermal desorption system using inductive heating according to some embodiments.

FIG. 15 illustrates another configuration for an induction heating system according to some embodiments.

FIG. 16 illustrates another configuration for an induction heating system according to some embodiments.

### DETAILED DESCRIPTION

In some embodiments, the invention relates to a process and apparatus for non-combustive thermal desorption of volatile contaminates from contaminated earth. The earth may include tar sand, oil sand, oil shale, bitumen, pond sediment, and tank bottom sediment. The concentration of the contaminates can be low concentration, e.g., less than about 3%, or high concentration, e.g., greater than about 3%. The process can provide cracking of the contaminates, and/or reclaiming condensable contaminates, then oxidizing and treating the non-condensable reclamation effluent, which can be recycled for use as the thermal desorption treatment gas.

The non-combustive thermal desorption of volatile contaminates from low concentration contaminated earth is described in U.S. Pat. No. 6,829,844 (Brady et al) which is incorporated herein by reference in its entirety. The thermal desorption is intended to remove organic contamination from porous media such as soil, rock, clays or other porous media with low organic contamination (less than 3% organic contamination) where desiccated electrically heated atmospheric air is used as the primary treatment gas. High organic contamination (greater than 3%) requires an inert (low oxygen) treatment gas to preclude explosions.

In some embodiments, the present invention, an evaporative desorption and/or reclamation process, can be cost effectively constructed to any scale and can exceed the 10 ton per hour production rate of indirect rotary kilns. The method can rely on hot air moving through a static volume of porous media. No mixing mechanisms for the porous media are required for treatment. In addition the process can recycle its heated treatment gas supply, minimizing energy required for treatment.

In some embodiments, the invention relates to a process and apparatus for thermal desorption of contaminates from a mixture of soil and rocks using desiccated, non-combustion-heated fresh treatment gas, such as air, to treat the soil and rocks which have been excavated and placed in a thermally conductive treatment container which is then placed in a thermally insulated treatment chamber. The fresh, hot, desiccated air is drawn through the soil treatment container, cooled, and released; or discharged to a treatment system, as required or needed, prior to release to the atmosphere.

In some embodiments, a thermal desorption technique applied to a static configuration of contaminated soil using a container arrangement is provided. The thermal desorption technique can restore the soil to its un-contaminated condition by removing the contamination within the soil through the evaporative desorption process. To provide an efficient remediation process, different temperature settings can be used to treat different contaminated soil, and thus sample of the contaminated soil can be tested to determine appropriate treatment conditions.

The treatment process for thermal desorption of hydrocarbon contaminants from excavated soil provides efficient contaminant removal by handling the soil in a thermally conductive soil box that is contained in an insulated treatment chamber for treatment. The soil is treated with dry hot air to remove contaminants, and the decontaminated soil can be returned to the ground.

In some embodiments, systems and methods to treat contaminated soil are provided, including soil box designs with ease of operation and improved decontamination efficiency and throughput. Simple flow path with minimum turns for the vapor extraction flow paths, such as a large diameter vapor extraction trunk positioned in a middle of the soil box, can provide maximum air flow with minimal head loss. Condensation reduction soil box designs can reduce treatment time, for example, through heating the center of the soil box to reduce condensation within the core of the soil bed or through heating the lower portions of the soil box to reduce temperature stratification. Pedestal connection with self sealing feature can eliminate the need for physical connection of the soil box with the external vapor extraction processing line.

In some embodiments, systems and methods are provided to supply thermal desorption of high-concentration hydrocarbon contaminants from excavated soil, such as tar sand, oil sand, oil shale, bitumen, pond sediment, and tank bottom sediment. The systems can provide efficient contaminant removal by handling the soil in a thermally conductive soil box that fits within an insulated treatment chamber. The soil is treated in this chamber with hot dry treatment gas. The contaminates can be reclaimed from the soil box. A portion of the contaminates, such a non-condensable hydrocarbon contaminates, can be used for effluent conditioning, for example, to maintain a desired treatment gas temperature in the soil box.

Contaminated earth (soil and rocks or other earthy material) that has been excavated is placed in a thermally conductive soil box which is then placed in a thermally insulated treatment chamber. Heated treatment gases can be introduced to the soil box and flow through the soil box and the contaminated earth. Hot gas extraction, e.g., treatment gases containing contaminates, can be withdrawn from the treatment chamber. The process is continued until the contaminates are completely removed from the soil, e.g., below a desired contamination level.

In some embodiments, the contaminates can be reclaimed from the hot gas extraction, for example, through a heat exchanger to cool and separate the condensable contaminates. The remaining hot gas extraction can be treated in a combustion or electrically heated thermal oxidizer, for example, to remove non-condensable contaminates. The output from the thermal oxidizer can be partially recycled to the treatment chamber as the treatment gas, or to maintain the temperature of the treatment chamber.

The soil box can have sides to contain the contaminated soil. For example, the soil box can be an open top rectangular cube, prism or cylinder. The soil box can also have a gas exit pathway within the contaminated soil so that gases in the contaminated soil flow to the gas exit pathway.

The treatment chamber can have an opening so the soil box may be inserted or removed, a gas inlet to receive hot dry gas, which can be directed to the soil box, and a gas outlet arranged to be mated with the gas exit pathway of the soil box so the gases in the contaminated soil exit the treatment chamber.

A heater and drier assembly can be arranged so that the incoming treatment gas to the treatment chamber is dried and heated upon entering the treatment chamber. A blower assembly can be arranged to direct the hot gas extraction from the soil box to exit the treatment chamber.

Dry, heated incoming treatment gas can be provided to the soil box, for example, to the opening of the soil box and/or to the sides of the soil box, to transferring heat to the contaminated soil, inducing the migration of contaminates through the soil to the gas exit pathway. The heated treatment gas flows through the contaminated soil, directly heating the soil before entering the gas exit pathway and exiting the chamber, carrying the contaminates.

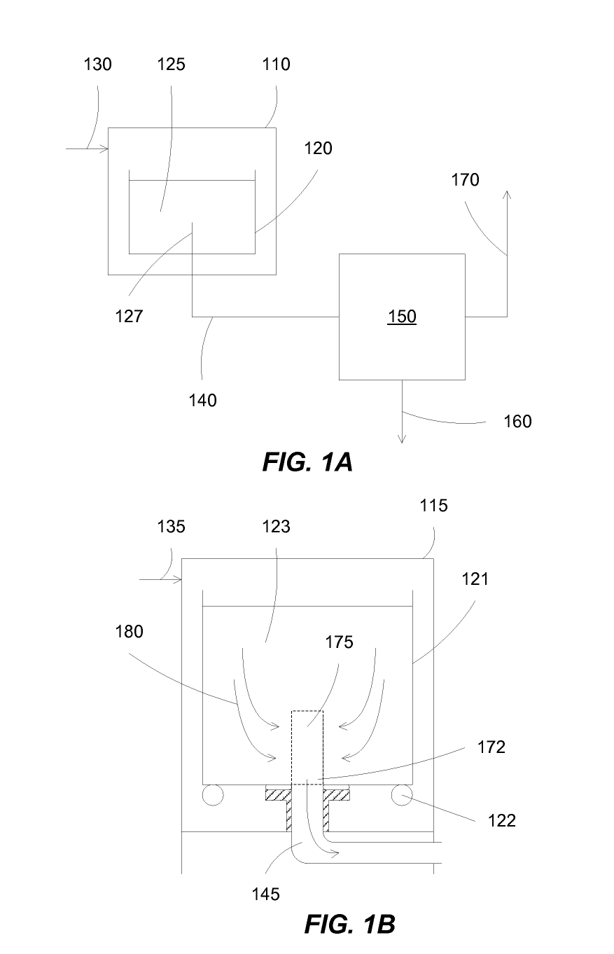

FIGS. 1A-1B illustrate schematic evaporative desorption systems according to some embodiments. In FIG. 1A, one or more soil boxes 120 can be placed in a treatment chamber 110. The treatment chamber can be insulated to prevent heat loss. The soil boxes can be open on top and contain a gas exit pathway 127. The soil boxes, after filled with contaminated soil 125, can be installed in the treatment chamber 110 for contamination treatment, and can be removed after the contamination treatment is complete. The soil boxes can provide for a batch process for contaminated soil and clean soil. Hot and dry treatment gas 130 can be introduced to the treatment chamber 110. The treatment gas can pass through the contaminated soil in the soil box to the gas exit pathway 127 coupled to the treatment chamber exhaust 140, and then flow out of the treatment chamber 110.

The exhausted treatment gas can contain hydrocarbon contaminates, which can be recovered. A recovering assembly 150 can be coupled to the treatment chamber exhaust 140 to recover all or a portion of the hydrocarbons in the exhaust treatment gas. The recovering assembly 150 can include one or more heat exchangers and a gas extraction fan, which provides the flow of treatment gas from the treatment chamber 110 through the heat exchangers. The contaminates can be condensed and flow to a phase separator to recover the condensate from heat exchangers. Heavy organics, light organics, and water can be separated in the phase separator and flow 160 through the outlets to collection tanks. Remaining residues can be exhausted 170 to a smoke stack.

FIG. 1B shows a soil box positioned in a treatment chamber according to some embodiments. The soil box 121 is a removable, sometimes called a roll-off, hopper modified to contain the gas exit pathway 172. The open-top soil box 121 can be supported by rollers 122 or steel rails (not shown) in the bottom. The treatment chamber 115 can accept a hot and dry treatment gas 135, such as desiccated air. The treatment gas can enter the soil 123, flow 180 toward the gas exit pathway 175, carrying away the contaminants within the soil. The treatment chamber 115 can be thermal insulated. The soil box 121 contains a gas exit pathway 172 located near the bottom of the soil box. The gas exit pathway can be perforated to allow flow of treatment gas from the surrounding soil into the pathway. The soil box 121 can be installed on a pedestal soil box support that provides a flow path from the soil box gas exit pathway 172 to provide for treatment gas and contaminants from the treatment chamber to exit 145 the chamber.

The soil box generally is the thermally conductive vessel used to contain and treat contaminated soil inside the EDU treatment chamber. The soil box can be constructed with vapor extraction lines at the bottom of the soil box. The soil 123 contained within the soil box presents the largest frictional head loss through the entire treatment gas flow path.

In some embodiments, the vapor extraction lines can have stainless steel wire wrap well screen to provide the maximum open area for vapor flow. The well screen also can be double wall with thermally resistant filter media such as steel wool or well pack sand.

In some embodiments, the vapor extraction lines and vapor flow path can require a simple flow path without unnecessary turns to improve the flow efficiency. The vapor extraction line design can include a large diameter vapor extraction trunk with smaller wire wrap well screens. The small well screens can be double walled with thermally resistant packing material in the annulus. The small screens can offer more open area for vapor flow and eliminate unnecessary turns in the vapor flow path. The center vapor extraction trunk draws all vapors to the center of the soil box. Condensation zones can be reduced or eliminated.

One end of the treatment chamber can contain an opening that allows one or more soil boxes to be inserted and removed from the treatment chamber. Soil boxes can be approximately 5 feet high, 5 feet wide, and up to 40 feet long, but may be as small as 8 feet long, in which case the treatment chamber is configured to hold two or more of them. The soil box can be inserted into the housing treatment chamber and removed by rolling or sliding the vessel via forklift or modified loader. Doors can be provided. A gas delivery conduit can be provided at a side of the treatment chamber. A pedestal support can be provided for mating with the soil box.

A forklift or modified loader can be used to transport the soil box and the soil contained in it to and from the treatment chamber location. The contaminated soil, once loaded in the soil box at the contamination site, is not removed from the soil box until treatment is complete and it is ready to be returned to a soil disposition site.

The treatment chamber can have insulated doors in open or close positions. In the open position the soil box, filled with soil can be easily installed or removed, for example, by a fork lift or a loader. A gas delivery conduit can provide hot dray treatment gas to the chamber. An explosion relief vent provides for venting of the pressurized content of the treatment chamber in the event of rapid pressure increase. The relief vent can direct the expelled gasses upward. The doors can be closed for processing.

In some embodiments, the present invention discloses systems and methods to treat contaminated soil, including an induction heating system for more efficient energy consumption. Induction power can be generated from an electromagnetic field, for example, through an inductive coil. Induction power applied directly to the heating recipient components, minimizing heat loss to the surrounding environment. Induction power can be applied directly to the soil box, heating the soil box and the soil inside the soil box. Heat absorbed elements, e.g., inductively heatable elements, such as steel pipe containing iron, can be placed in the soil box for accepting the inductive power. The inductively heatable elements can include conductive materials, in which the eddy current caused by the electromagnetic field can generate thermal energy to heat the materials. High electrical resistance materials can generate higher thermal energy due to the resistance against the eddy current. The inductively heatable elements can include magnetic materials, such as ferrous or ferric materials, in which the magnetic hysteresis loss can generate thermal energy to heat the materials. High relative permeability, higher than 100 or 500, materials can provide higher thermal energy. High relative permeability materials can include iron and iron alloys or compounds such as steel, stainless steel, cobalt, manganese, zinc, and nickel.

In some embodiments, induction power can be used to heat the input gas, providing an efficient method to heat the treatment gas. The input gas can be supplied to the heat the soil box, for example, heating the exposed soil surface and the soil box sides. The input gas can be supplied to inner elements, such as pipes located inside the soil box for heating the soil from the inside. The pipes can have openings, for example, along the pipe length or at the ends of the pipes, to release the hot gas to the surrounding soil. In some embodiments, induction power can be used to directly heating the inner pipes that are placed in the soil box. The inductive coils placed at the inner pipes, e.g., surrounding the inner pipes, can heat the input gas at the locations inside the soil box, providing an efficient way of heating the inner soil.

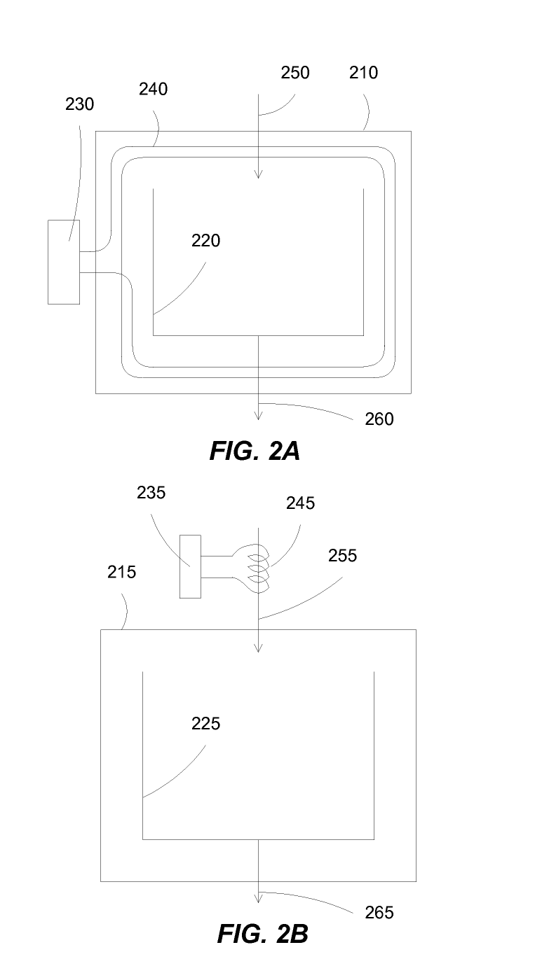

FIGS. 2A-2B illustrate induction heating systems for a thermal desorption process according to some embodiments. In FIG. 2A, an induction system can be used to heat a treatment chamber. For example, an inductive coil can surround a treatment chamber, to generate an electromagnetic field to heat inductively heatable elements inside the treatment chamber. The inductive coil can run from a sidewall to the top wall to another sidewall to the bottom wall of the treatment chamber. The inductive coil can be configured to leave a front side open for moving a soil box in and out of the treatment chamber.

A soil box 220 can be configured to hold contaminated soil, and can be placed in a treatment chamber 210. The soil box 220 can be configured accept and retain thermal energy from an induction system 230, for example, including an induction coil 240 to generate electromagnetic field. The soil box 220 can include magnetic materials, such as iron, which can absorb the radiation from the induction system. In addition, magnetic materials, such as rods or balls, can be placed in the soil box, which can also absorb radiation from the induction system. Under the electromagnetic radiation from the induction system, the soil box and/or the magnetic rods can be heated up, which can heat the soil in the soil box to vaporize the volatile contaminants. The vaporized contaminants can be exhausted from the top surface, or from the bottom of the soil. For example, vapor extraction lines 260 can be provided on the floor to extracting volatile contaminants, which can be more efficient than vapor extraction from to top surface.

In some embodiments, the soil box can accept an input gas 250, which can be at room temperature, or can be preheated, for example, by a preheating system using the same induction effect.

FIG. 2B shows another configuration for an induction heating system according to some embodiments. A treatment chamber 215 can be configured to house a soil box 225 for holding the contaminated soil. Vapor extraction lines 265 can be include for extracting vapor contaminants. An input gas 255 can be heated by an induction system 235, including an inductive coil 245, for heating the input gas 255 that can be used for heating the contaminated soil. In addition to the induction heating system for heating the input gas, another induction system can be used for heating the soil box, or for heating heatable elements in the soil box.

In some embodiments, the inductive heatable elements can include the soil box or addition elements inside the soil box for heating the soil. The inductive heatable elements can be coupled to the soil box, e.g., connected to the soil box, or can be loose, e.g., dispersed within the soil.

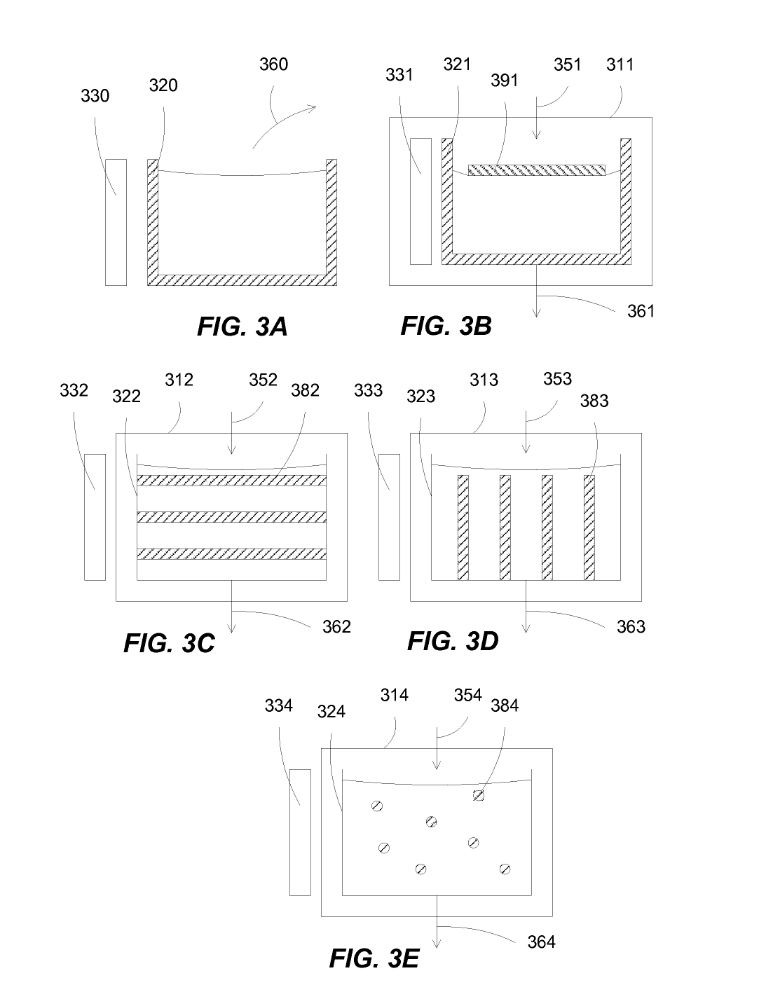

FIGS. 3A-3E illustrate soil box configurations having inductive heatable elements according to some embodiments. In FIG. 3A, an inductive generator 330 can generate electromagnetic field to a soil box 320. The soil box can include inductive heatable materials, such as conductive materials for eddy current heating, or high permeability materials for hysteresis loss heating. The inductive generator can include a power generator and an inductive coil surrounding the soil box. The soil box can absorb the radiation from the inductive generator to become heated. The heated soil box can heat the contaminate soil in the soil box, desorbing 360 the volatile contaminate.

In FIG. 3B, the soil box 321 and the inductive generator 331 can be placed in a treatment chamber 311. Alternatively, a portion of the generator 331, such as the power generator, can be placed outside the treatment chamber, and a inductive coil can be placed around the treatment chamber, either outside or inside. The soil box 321 can include inductive heatable materials, such as conductive materials for eddy current heating, or high permeability materials for hysteresis loss heating. A lid 391, which can also include inductive heatable materials, can be used for heating the top portion of the soil. An inlet gas 351 can be introduced to the treatment chamber. The inlet gas 351 can be heated outside of the treatment chamber, for example, by an inductive heater system. The inlet gas 351 can be at room temperature, or at any temperature, and can be heated when in contact with the soil, extracting the contaminants to exhaust 361 the soil box and the treatment chamber.

In FIG. 3C, the soil box can include horizontal bars 382, which can include inductive heatable materials, such as conductive materials for eddy current heating, or high permeability materials for hysteresis loss heating. The soil box 322 can also include inductive heatable materials, or can include other materials. Radiation from an inductive generator 332 can pass to the treatment chamber 312, heating the horizontal bars 382, which in turn, can heat the soil to a temperature that can desorb the contaminants. An inlet gas 352 can be introduced to the treatment chamber. The inlet gas 352 can be heated outside of the treatment chamber, for example, by an inductive heater system. The inlet gas 352 can be at room temperature, or at any temperature, and can be heated when in contact with the soil, extracting the contaminants to exhaust 362 the soil box and the treatment chamber.

The horizontal bars can be placed at any angle, such as vertical. In addition, elements having different geometry such as tubes, rods, straight or curve can be used. In FIG. 3D, the soil box can include vertical bars 383, which can include inductive heatable materials, such as conductive materials for eddy current heating, or high permeability materials for hysteresis loss heating. The soil box 323 can also include inductive heatable materials, or can include other materials. Radiation from an inductive generator 333 can pass to the treatment chamber 313, heating the vertical bars 383, which in turn, can heat the soil to a temperature that can desorb the contaminants. An inlet gas 353 can be introduced to the treatment chamber. The inlet gas 353 can be heated outside of the treatment chamber, for example, by an inductive heater system. The inlet gas 353 can be at room temperature, or at any temperature, and can be heated when in contact with the soil, extracting the contaminants to exhaust 363 the soil box and the treatment chamber.

Other configurations can be used, in addition to the horizontal or vertical bars. For example, scraps of inductive heatable materials can be dispersed in the soil for heating the soil. In FIG. 3E, balls 384 can be mixed with the soil in the soil box. The balls can include inductive heatable materials, such as conductive materials for eddy current heating, or high permeability materials for hysteresis loss heating. Other shapes can also be used, such as rod, cylinder, or an irregular shape. The soil box 324 can also include inductive heatable materials, or can include other materials. Radiation from an inductive generator 334 can pass to the treatment chamber 314, heating the balls 384, which in turn, can heat the soil to a temperature that can desorb the contaminants. An inlet gas 354 can be introduced to the treatment chamber. The inlet gas 354 can be heated outside of the treatment chamber, for example, by an inductive heater system. The inlet gas 354 can be at room temperature, or at any temperature, and can be heated when in contact with the soil, extracting the contaminants to exhaust 364 the soil box and the treatment chamber.

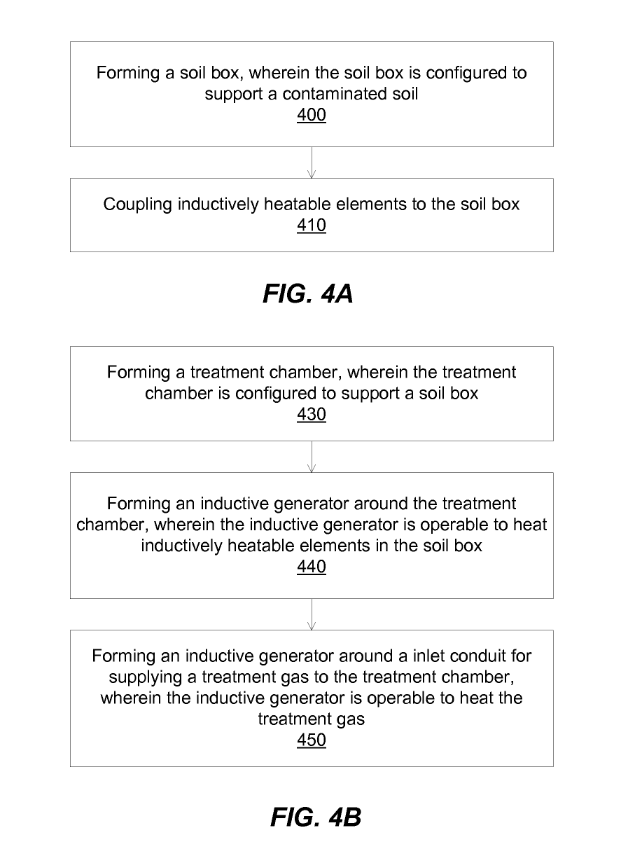

FIGS. 4A-4B illustrate flow charts for forming systems to treat contaminate soil according to some embodiments. In FIG. 4A, a soil box can be formed for inductive heating contaminate soil. Operation 400 forms a soil box. The soil box can be configured to support a contaminated soil. Operation 410 couples inductively heatable elements to the soil box. The inductively heatable elements can include materials that can be heated by an induction coil, e.g., by a magnetic field or an electromagnetic field. The inductively heatable elements can include high resistivity materials that can have eddy current that can generate thermal energy. The inductively heatable elements can include high permeability materials that can have high hysteresis loss that can generate thermal energy. The high permeability materials can include materials having relative permeability greater than 100, or greater than 200, or greater than 500, such as iron, iron alloys or compounds such as steel, stainless steel, cobalt, manganese, and nickel.

In FIG. 4B, a treatment chamber can be form for generating inductive energy for heating inductively heatable materials in a soil box. Operation 430 forms a treatment chamber. The treatment chamber can be configured to support a soil box. Operation 440 forms an inductive generator around the treatment chamber. The inductive generator can be operable to heat inductively heatable elements in the soil box. For example, the inductive generator can include a power generator and an inductive coil, which can be configured to surround the treatment chamber, and thus surround the soil box when the soil box is placed in the treatment chamber for treating. The power generator can be placed outside the treatment chamber. The inductive coil can be placed inside or outside the treatment chamber. Operation 450 optionally forms an inductive generator around a inlet conduit for supplying a treatment gas to the treatment chamber. The inductive generator can be operable to heat the treatment gas. The heated treatment gas can be used to heat the contaminate soil, removing the contaminants in the contaminate soil.

In some embodiments, the present invention discloses treatment systems and methods for thermal desorption of contaminate soil using inductive energy. A treatment chamber can have an inductive energy generator configured to heat inductively heatable elements in or contacting the contaminate soil. For example, the contaminate soil can be placed in a soil box. The soil box can have inductively heatable elements disposed inside the soil box, for contacting the soil for heating the soil. Heated treatment gas can be introduced to the treatment chamber, passing through the heated contaminate soil, and then exhausting through an exhaust conduit, carrying the contaminants.

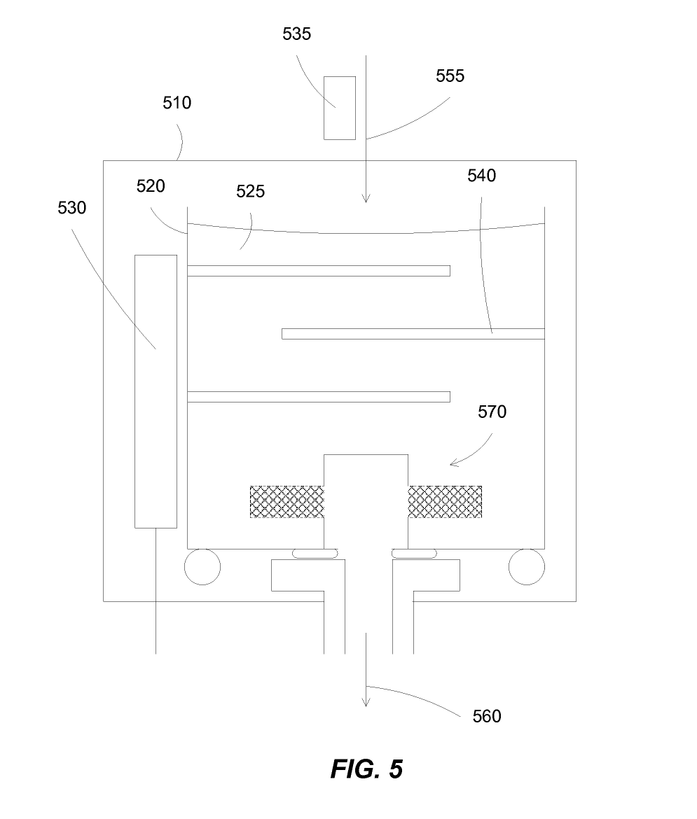

FIG. 5 illustrates a soil box positioned in a treatment chamber according to some embodiments. The soil box 520 is a container that can be removed from the treatment chamber. The soil box can include inductively heatable elements such as horizontal rods 540, distributed for efficiently heating the soil 525. For example, the rods 540 can be disposed in a way to evenly heating the soil. An inductive energy generator 530 can be used to heat the inductively heatable elements, for example, through magnetic field or electromagnetic field generated by the generator 530 and absorbed by the inductively heatable elements.

The treatment chamber 510 can accept a treatment gas 555, such as air. The treatment gas can be heated, for example, by an inductive energy generator 535. The treatment gas can enter the soil 525, flow toward the gas exit pathway 570, carrying away the contaminants within the soil to an exhaust 560. The soil box 520 contains a gas exit pathway 570 located near the bottom of the soil box.

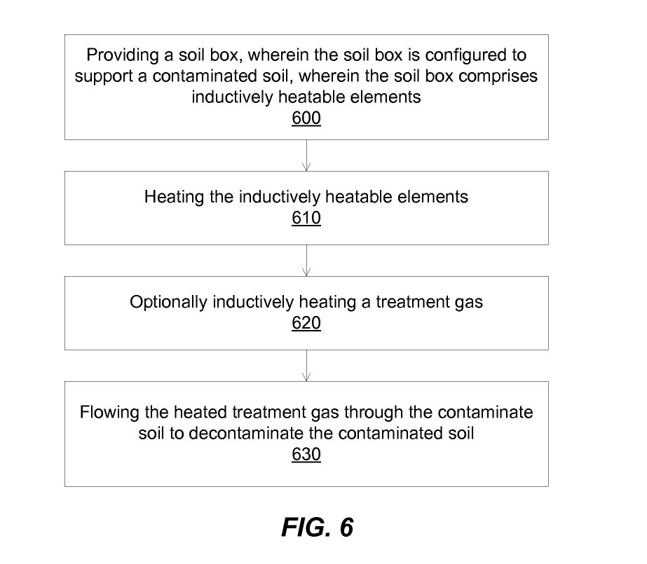

FIG. 6 illustrates a flow chart for treating contaminate soil according to some embodiments. Operation 600 provides a soil box. The soil box is configured to support a contaminated soil. The soil box comprises inductively heatable elements. Operation 610 heats the inductively heatable elements. Operation 620 optionally inductively heats a treatment gas. Operation 630 flows the heated treatment gas through the contaminate soil to decontaminate the contaminated soil.

In some embodiments, inductively heatable elements can be dispersed in the contaminate soil to heat the soil through the absorbed inductive energy. The inductively heatable elements can be added to the soil before the treatment, and then removed following the treatment. Since the inductively heatable elements can include high permeability materials such as containing iron, a magnet can be used to remove the inductively heatable elements from the soil.

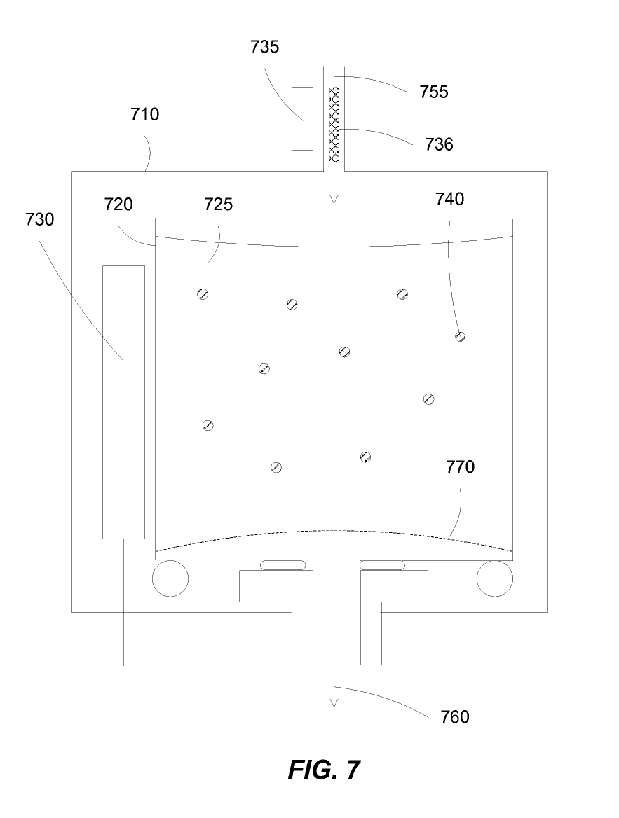

FIG. 7 illustrates a soil box positioned in a treatment chamber according to some embodiments. The soil box 720 can be configured to contain contaminate soil 725. The soil can include inductively heatable elements such as balls 740, mixed in the soil for efficiently heating the soil 725. An inductive energy generator 730 can be used to heat the inductively heatable elements, for example, through magnetic field or electromagnetic field generated by the generator 730 and absorbed by the inductively heatable elements.

The treatment chamber 710 can accept a treatment gas 755, such as air. The treatment gas can be heated, for example, by an inductive energy generator 735. Inductive heatable elements 736 can be disposed in the treatment gas inlet to be heated by the inductive energy generated from the generator 735. When passing through the inductive heatable element 736, the treatment can be heated, for example, by collision with the heated inductive heatable elements 736. The treatment gas can enter the soil 725, flow toward a mesh 770, and carry away the contaminants within the soil to an exhaust 760. The soil box 720 contains a curve mesh 770 located near the bottom of the soil box to collect the treatment gas to the exhaust.

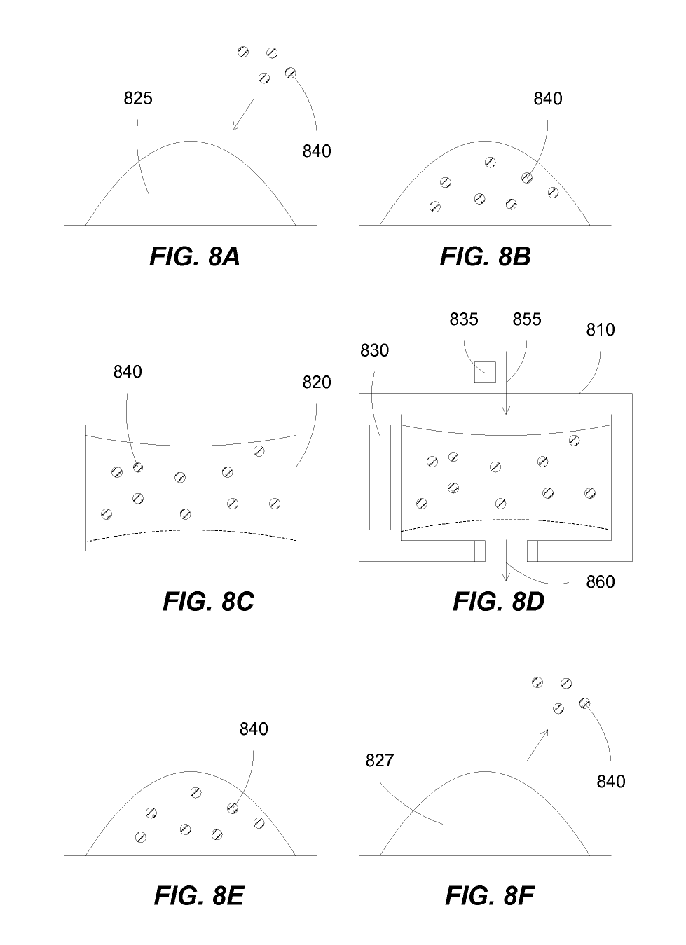

FIGS. 8A-8F illustrate a sequence of treatment using dispersed inductively heatable elements according to some embodiments. In FIG. 8A, inductively heatable elements 840, such as steel balls, can be added to contaminated soil 825. In FIG. 8B, the inductively heatable elements 840 can be mixed to evenly disperse the inductively heatable elements 840 in the soil 825. In FIG. 8C, the soil 825 and the inductively heatable elements 840 can be placed in a soil box 820. Alternatively, the soil 825 can be placed in the soil box 820, and the inductively heatable elements 840 can be added to the soil box.

In FIG. 8D, the soil box is placed in a treatment chamber 810. An inductive energy generator 830 can heat the inductively heatable elements, which can heat the soil in the soil box. An input gas 855, which can also be heated by a heater 835, can pass through the heated soil to carry away the contaminants to the exhaust 860. In FIG. 8E, the soil, and the inductively heatable elements 840 can be removed from the soil box. In FIG. 8F, a magnet can be used to remove the inductively heatable elements 840 from the soil, leaving a clean soil 827.

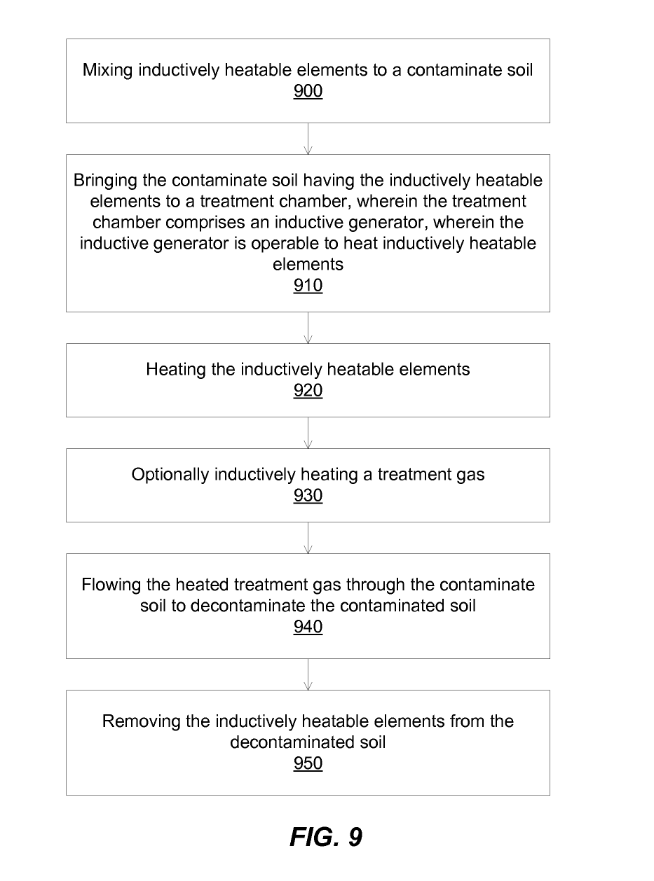

FIG. 9 illustrates a flow chart for processing a contaminate soil according to some embodiments. Operation 900 mixes inductively heatable elements to a contaminate soil. Operation 910 brings the contaminate soil having the inductively heatable elements to a treatment chamber. The treatment chamber comprises an inductive generator. The inductive generator is operable to heat inductively heatable elements. Operation 920 heats the inductively heatable elements. Operation 930 optionally inductively heats a treatment gas. Operation 940 flows the heated treatment gas through the contaminate soil to decontaminate the contaminated soil. Operation 950 removes the inductively heatable elements from the decontaminated soil.

In some embodiments, treatment gas can be heated by induction heating. An inductive generator can generate an electromagnetic field in a treatment chamber. Inductively heatable elements can be disposed in the soil, and the treatment gas can pass through the inductively heatable elements, to be heated, and then passing through the contaminate soil to remove the contaminants.

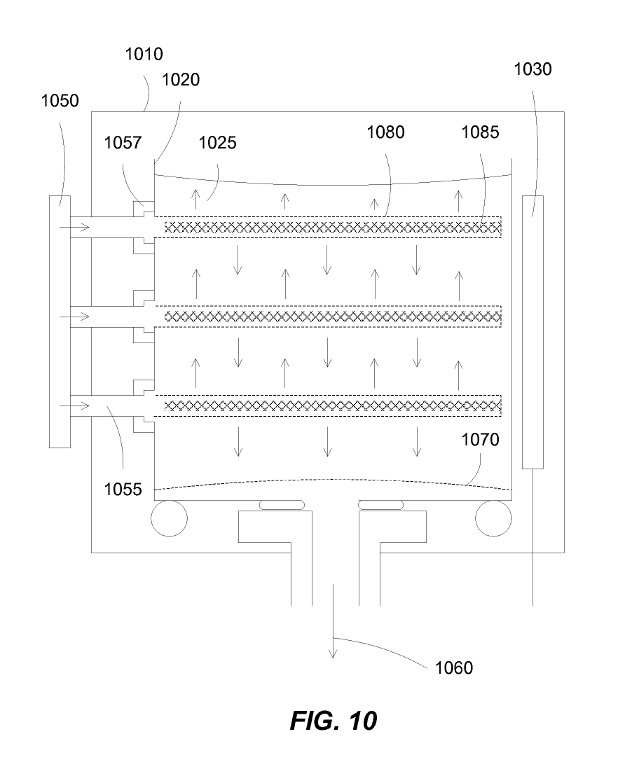

FIG. 10 illustrates a thermal desorption system using inductive heating according to some embodiments. Input treatment gas, such as air or dry air, can flow to a treatment chamber 1010, for example, through a manifold 1050, through conduits 1055 to a soil box 1020. The soil box can include inductively heatable elements 1085, disposed inside mesh conduits 1080. The mesh conduits can include screen pipes, such as well screen tubes. The inductively heatable elements can include porous materials disposed in the mesh conduit. The inductively heatable elements can include fiber materials or other small pieces of materials, which can be heated and then transfer the heat to the coming treatment gas. The input treatment gas can pass through the inductively heatable elements 1085, and through holes in the mesh 1080 to the soil 1025. An inductive generator 1030 can generate the inductive energy to heat the inductively heatable elements 1085. Thus the system can be heated from inside of the soil. The treatment gas can extract the contaminants in the soil, and exhaust 1060 through the bottom screen 1070 to the exhaust port.

Connection ports 1057 can be used to couple the conduit 1055 to the soil box, e.g., to the mesh conduits 1080 in the soil box. The connection ports 1057 can allow the treatment gas to come from the manifold 1050 to the inside of the soil in the soil box.

The connection ports can be movable, e.g., retracting for removing and placing the soil box, and extending for coupling with the soil box after the soil box has been placed in the treatment chamber. Alternatively, automatic seal can be used, in which the connection ports are automatically coupled to the soil box when the soil box is placed in the treatment chamber.

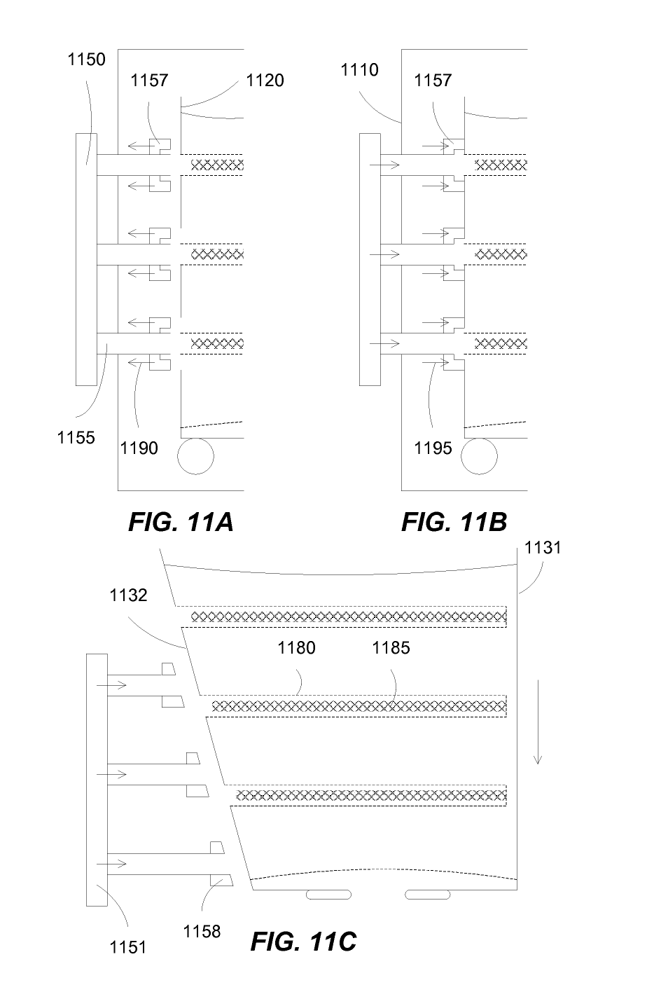

FIGS. 11A-11C illustrate connection ports for treatment gas coupling according to some embodiments. In FIG. 11A, the connection ports 1157 is in a retracted state 1190. Thus a soil box 1120 can be taken out or brought in the treatment chamber 1110. In FIG. 11B, the connection ports 1157 is in an extended state 1195, for example, after the soil box 1120 has been placed in the treatment chamber 1110. After extending, the connection ports can be sealed with the soil box surface, e.g., to deliver treatment gas from the input gas manifold 1150 to the gas conduits 1155 to the inside of the soil in the soil box. The connection ports 1157 can be spring-loaded to allow retracting and extending. Also, the connection ports can be coupled to a mechanism, linking the door of the treatment chamber to the retract/extend mechanism of the connection ports. For example, when the door is open, the mechanism automatically retracts the connection ports, e.g., to allow removal or placing the soil box. When the door is close, the mechanism automatically extends the connection ports, e.g., to allow treatment gas to enter the soil in the soil box.

FIG. 11C shows another configuration for the connection ports. The soil box 1131 can have a slanted sidewall 1132, with the mesh conduits 1180 and the inductively heatable elements 1185 coupled to the slanted sidewall 1132. The manifold 1151 can have connection ports 1158 configured to mate with the slanted sidewall of the soil box.

In operation, the soil box can be lifted up and brought to the treatment chamber. When dropping down, the sidewall of the soil box can mate with the connection ports 1158.

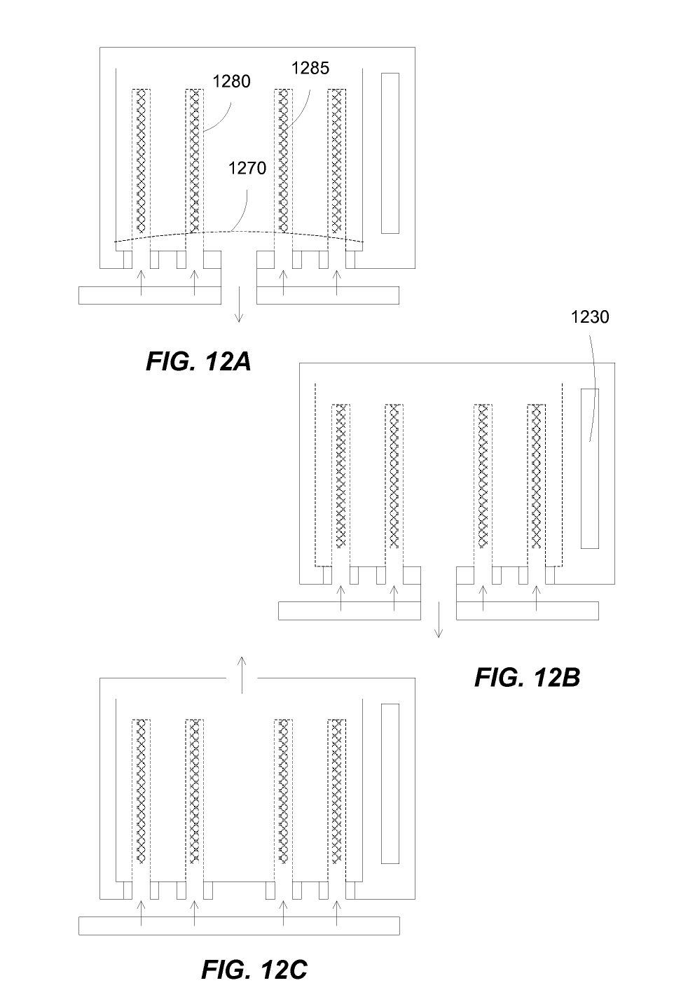

FIGS. 12A-12C illustrate thermal desorption systems using inductive heating according to some embodiments. In FIG. 12A, the mesh conduit 1280 containing inductively heatable elements 1285 can be placed vertically, with connection ports at a bottom of the soil box to be connected to gas manifold. A screen 1270 can be placed at a bottom of the soil box for collecting the exhaust gas. In FIG. 12B, the exhaust gas can be directly released to the exhaust, e.g., without the screen. In FIG. 12C, the exhaust gas can be released to the top portion (or to any other portion) of the treatment chamber, instead of to the bottom portion.

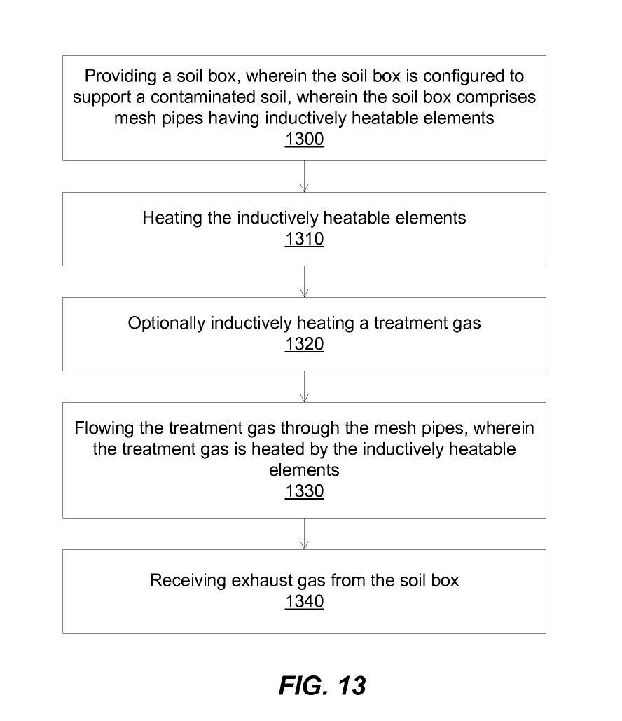

FIG. 13 illustrates a flow chart for treating contaminate soil according to some embodiments. Operation 1300 provides a soil box, wherein the soil box is configured to support a contaminated soil, wherein the soil box comprises mesh pipes having inductively heatable elements. Operation 1310 heats the inductively heatable elements. Operation 1320 optionally inductively heats a treatment gas. Operation 1330 flows the treatment gas through the mesh pipes, wherein the treatment gas is heated by the inductively heatable elements. Operation 1340 receives exhaust gas from the soil box.

In some embodiments, inductively heatable elements can be added to the soil in the soil box to increase heat sources, e.g., components that can absorb inductive energy to turn into thermal energy.

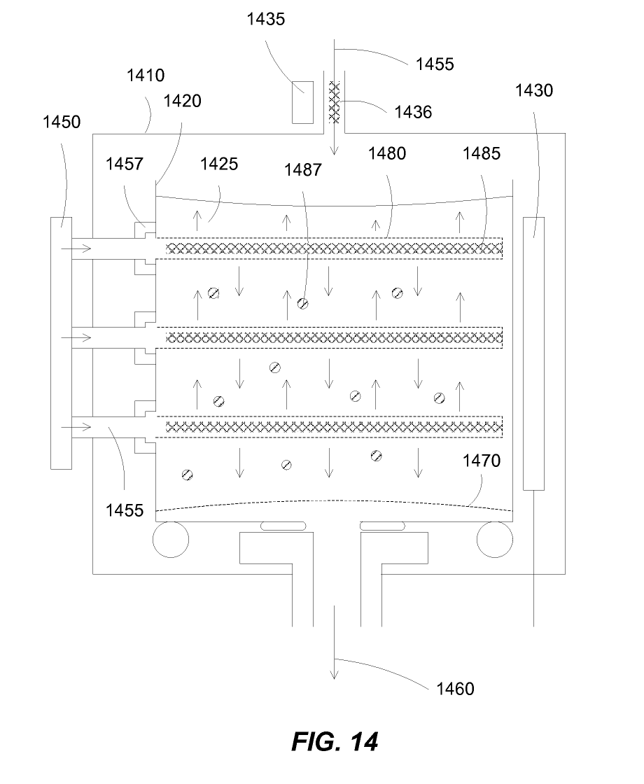

FIG. 14 illustrates a thermal desorption system using inductive heating according to some embodiments. Input treatment gas, such as air or dry air, can flow to a treatment chamber 1410, for example, through a manifold 1450, through conduits 1455 to a soil box 1420. The soil box can include inductively heatable elements 1485, disposed inside mesh conduits 1480. The input treatment gas can pass through the inductively heatable elements 1485, and through holes in the mesh 1480 to the soil. The treatment gas can extract the contaminants in the soil, and exhaust 1460 through the bottom screen 1470 to the exhaust port.

Connection ports 1457 can be used to couple the conduit 1455 to the soil box, e.g., to the mesh conduits 1480 in the soil box. The connection ports 1457 can allow the treatment gas to come from the manifold 1450 to the inside of the soil in the soil box.

Additional treatment gas 1455 can be added, with optional inductively heatable elements 1436 which is heated by inductive generator 1435. Inductively heatable elements, such as steel balls 1487, can be added to the soil 1425. Thus the inductive generator 1430 can heat the soil through the inductively heatable elements 1487, and can heat the treatment gas through the inductively heatable elements 1485.

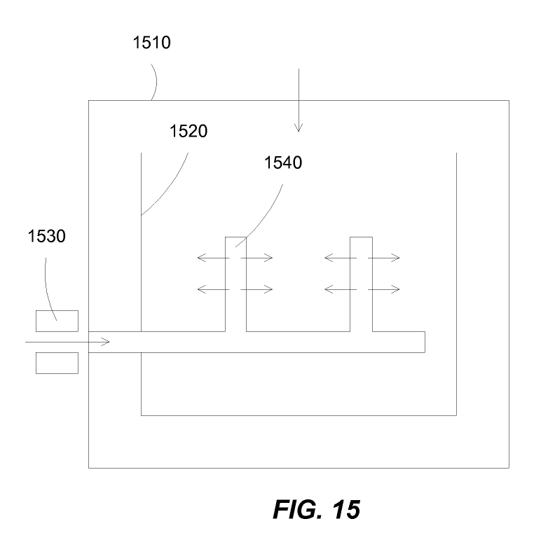

Other configurations using inductive energy to treat the contaminate soil can be used. FIG. 15 illustrates another configuration for an induction heating system according to some embodiments. A treatment chamber 1510 can be configured to house a soil box 1520 for holding the contaminated soil. Vapor extraction lines can be include for extracting vapor contaminants. An induction system 1530 can be used for heating an input gas, which can be delivered to embedded gas delivery elements 1540 in the soil box. The hot gas, heated from the induction system 1530, can be released to the surrounding soil in the soil box, heating the soil. Further, another optional input gas can be provided to the treatment chamber, for example, for heating the contaminated soil from the outside surfaces, such as from the open end of the soil box, or from the soil box walls.

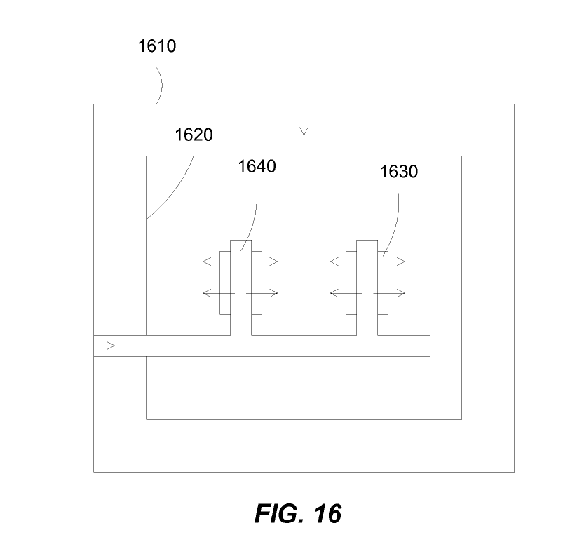

FIG. 16 illustrates another configuration for an induction heating system according to some embodiments. A treatment chamber 1610 can be configured to house a soil box 1620 for holding the contaminated soil. Vapor extraction lines can be include for extracting vapor contaminants. An induction system 1630 can be used for heating gases in an embedded gas delivery element 1640. The hot gas from the embedded gas delivery element 1640, which is heated from the induction system 1630, can be released to the surrounding soil in the soil box, heating the soil. Further, another optional input gas can be provided to the treatment chamber, for example, for heating the contaminated soil from the outside surfaces, such as from the open end of the soil box, or from the soil box walls. The induction system 1630 can also heat other embedded elements, such as radiation absorbed elements, to heat the soil by conduction. The induction system can provide thermal energy, e.g., heating electromagnetic absorbed elements such as iron containing materials, to the soil, either by direct heating the soil by conduction, or by heating input gas which can be released to the soil.

What is claimed is:

1. A method comprising:
forming a mixed soil by supplying inductively heatable elements to a contaminate soil;
bringing the mixed soil to a treatment chamber;
generating a magnetic field in the treatment chamber for inductively heating the inductively heatable elements;
removing contaminants in the mixed soil.

2. A method as in claim 1
wherein bringing the mixed soil to the treatment chamber comprises putting the mixed soil in a soil box and bringing the soil box to the treatment chamber.

3. A method as in claim 1
wherein the soil is mixed by supplying inductively heatable elements to a soil box containing contaminate soil.

4. A method as in claim 1 further comprising:
supplying a treatment gas to the treatment chamber, wherein the treatment gas passes through the mixed soil to remove the contaminants.

5. A method as in claim 1 further comprising:
inductively heating a treatment gas before supplying the heated treatment gas to the treatment chamber, wherein the treatment gas passes through the mixed soil to remove the contaminants.

6. A method as in claim 1 further comprising:
removing the inductively heatable elements from the mixed soil.

7. A method as in claim 1 further comprising:
placing a magnet near the mixed soil to remove the inductively heatable elements from the mixed soil.

8. A method comprising:
bringing a soil box to a treatment chamber, wherein the soil box is configured to contain a contaminate soil, wherein the soil box comprises at least a mesh conduit, wherein the mesh conduit comprises inductively heatable elements disposed in the mesh conduit;
flowing a treatment gas to a mesh conduit;
generating a magnetic field in the treatment chamber for inductively heating the inductively heatable elements;
exhausting the treatment gas.

9. A method as in claim 1
wherein the treatment gas is heated by contacting the heated inductively heatable elements.

10. A method as in claim 1
wherein the treatment gas passes through the contaminate soil to remove the contaminants.

11. A method as in claim 1 further comprising:
inductively heating a treatment gas before supplying the heated treatment gas to the mesh conduit.

12. A thermal desorption soil remediation system, comprising:
a treatment chamber, wherein an inside of the treatment chamber is configured to support a soil box;
a power generator;
an induction coil,
wherein the induction coil is coupled to the power generator,
wherein the induction coil is configured to provide a magnetic field to the inside of the treatment chamber.

13. A system as in claim 1
wherein the induction coil surrounds the treatment chamber.

14. A system as in claim 1
wherein the induction coil surrounds the treatment chamber from a first sidewall to a top wall to a second sidewall to a bottom wall of the treatment chamber.

15. A system as in claim 1 further comprising:
at least a connection port coupled to the treatment chamber,
wherein the connection port is protruded through a wall of the treatment chamber,
wherein the connection port is configured to make a seal with a sidewall of the soil box,
wherein the connection port is coupled to a gas supply source.

16. A system as in claim 1
wherein the connection port comprises a slanted angle for mating with a slanted sidewall of the soil box.

17. A system as in claim 1
wherein the connection port comprises a sliding sleeve for extending and retracting a length of the connection port.

18. A system as in claim 1 further comprising:
a first mechanism coupled to the connection port for extending and retracting the connection port.

19. A system as in claim 1 further comprising:
a second mechanism coupled to the connection port and to a door of the treatment chamber,
wherein the second mechanism is configured for retracting the connection port when the door is open,
wherein the second mechanism is configured for extending the connection port when the door is close.

20. A system as in claim 1 further comprising:
a second power generator and a second induction coil, configured for inductively heating an input gas to the treatment chamber.
